(19) United States
(12) Patent Application Publication
(10) Pub. No.: US 2008/0030033 A1
(43) Pub. Date: Feb. 7, 2008

(54) Pet waste scooping device

(76) Inventor: Harold Roy Taylor, Stratford, CT (US)

Correspondence Address: Lawrence Cruz;Conair Corporation, One Cummings Point Road, STAMFORD, CT, 06902, US

(21) Appl. No.: 11/497,450

(22) Filed: Aug. 1, 2006

(51) Int. Cl. A01K 29/00

(52) U.S. Cl. 294/1.4

(57) ABSTRACT

A beverage matter container (10) for holding coffee grounds (132), loose tea or the like, having a body portion (12) shaped like an open-top cup, a moveable or removable locking lid (14) for access to the interior of the body portion, and perforations (30) in the bottom of the body and in the lid (28) for allowing brewed beverage to pass through. The container is adapted to be inserted into a compartment in a beverage machine, such as into a drawer or space in the flow path of heated water or steam that may be delivered under pressure to the container, to pass therethrough, to mix with beverage matter held therein.

### CROSS-REFERENCE TO RELATED APPLICATIONS

None.

### TECHNICAL FIELD

The present invention relates to devices for scooping up materials from the ground and, more particularly, to devices for scooping up pet waste or animal waste.

### BACKGROUND OF THE INVENTION

Existing devices for scooping up animal or pet waste provide ways of efficiently and conveniently picking up and disposing of pet waste in a convenient manner. Certain devices facilitate the function of placing the waste into trash bags or similar disposable receptacles. It is particularly challenging to get such existing devices to work well in that bags are subject to tearing or mis-feeding, or the bags interfere with the scooping shovel elements, and other problems.

### OBJECTS OF THE INVENTION

It is an object of the present invention to provide a convenient, durable, and optimally performing scooping device for picking up and disposing of animal waste. This object and others are achieved by the present invention.

### BRIEF SUMMARY OF THE INVENTION

The present invention achieves the above-mentioned objects by utilizing a pick-up and disposal device having a pair pivoting shovel portions joined to a shaft having a handle end. The shaft and handle end are provided with an actuator mechanism that is configured for one-handed operation and that is used to selectively open and close the shovel jaws. A roll of disposal bags is attached inside the junction of the shovel jaws in a manner in which a single bag at a time can be dispensed over the shovel jaws so that waste can be retrieved directly into the bag. The bag is initially folded back and over the jaws and, after retrieval of waste, the bag is folded forward off of the jaws and tied off, so that the waste is enclosed in the tied bag. The bag is severed from the roll of bags at pre-existing perforations. An additional aspect of the invention includes a clip for attaching light such as a flashlight.

### BRIEF DESCRIPTION OF THE DRAWINGS

FIG. 1 is a perspective view of a device according to a first embodiment of the present invention.

FIG. 2 is a top view of a device according to a first embodiment of the present invention.

FIG. 3 is a side view of a device according to a first embodiment of the present invention.

FIG. 4 is a partial, perspective view of a device according to a first embodiment of the present invention showing jaws in an opened position.

FIG. 5 is a partial, side view of a device according to a first embodiment of the present invention showing jaws in an opened position.

FIG. 6 is a partial, side view of a device according to a first embodiment of the present invention showing jaws in a closed position with a bag folded back.

FIG. 7 is a partial, side view of a device according to a first embodiment of the present invention showing jaws in a closed position with a bag folded forward.

FIG. 8 is a side view of a bag according to the first embodiment of the present invention.

FIG. 9 is an orthogonal view of a device according to a second embodiment of the present invention.

FIG. 10 is a top view of a device according to a second embodiment of the present invention.

FIG. 11 is an end, cross-sectional view of a device according to a second embodiment of the present invention.

FIG. 12 is an orthogonal view of a device according to a second embodiment of the present invention shown in an opened condition.

FIGS. 13A-13D are orthogonal illustrations of sequential steps for a method according to the second embodiment of the present invention.

FIG. 14 is an orthogonal view of a device according to a second embodiment of the present invention positioned in a beverage maker drawer component.

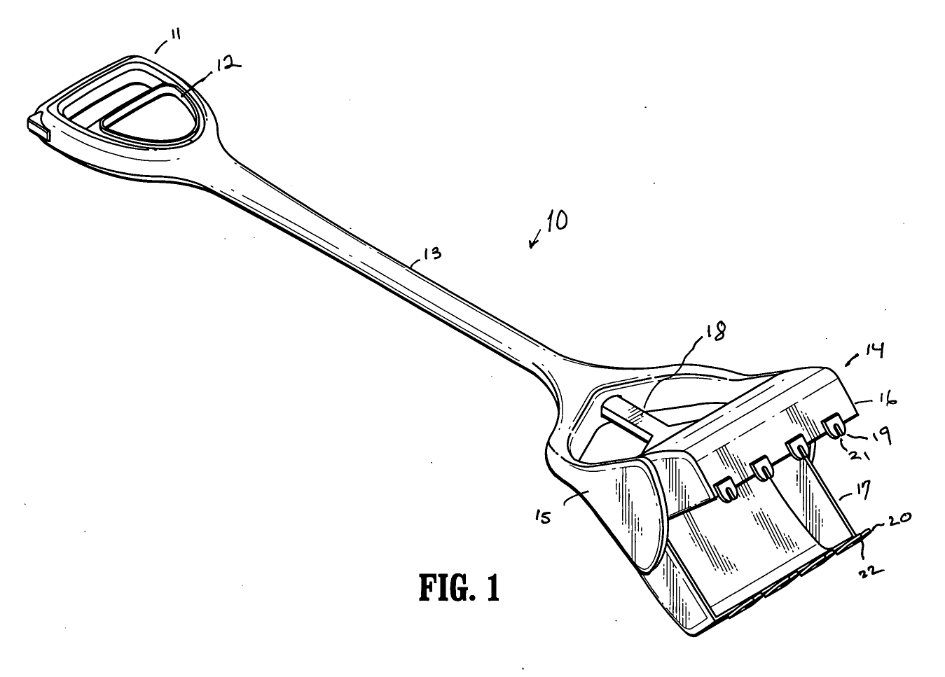

### DESCRIPTION OF THE PREFERRED EMBODIMENTS

While certain embodiments of the present invention are disclosed herein as preferred embodiments, the present invention is not limited to these particular embodiments. For example, an assembly according to the present invention can be configured selectively to be suitable as a hair ornament or hair retention device, as a necklace, as a bracelet, as a belt loop, as a belt, as an anklet, as a strap or decorative accessory for a purse or bag, as a decorative accessory for footwear such as a boot or for headwear such as a hat, or as a decorative accessory for clothing such as a jacket or a pair of jeans. These are examples and there are many other possibilities.

A beverage container according to the present invention is suitable for holding and filtering beverage matter such as coffee grounds or loose tea, or other matter, during a brewing procedure in which liquid, heated liquid, or steam is passed through the container. The container may be used in a variety of coffee, tea or other beverage makers, including but not limited to one or more types generally known, and is not limited to any one design, so long as a space or compartment exists that is adapted to receive a filter and beverage matter, a filter packet, a pod, or the like, and is able to receive the container therein. The container according to the present invention can be sized and shaped to fit the space or compartment to sufficiently fill the space and channel water, heated water or steam through in order to brew a beverage.

The container may be made of plastic, metal, ceramic, or another suitably strong and heat-resistant material, or a combination of the foregoing.

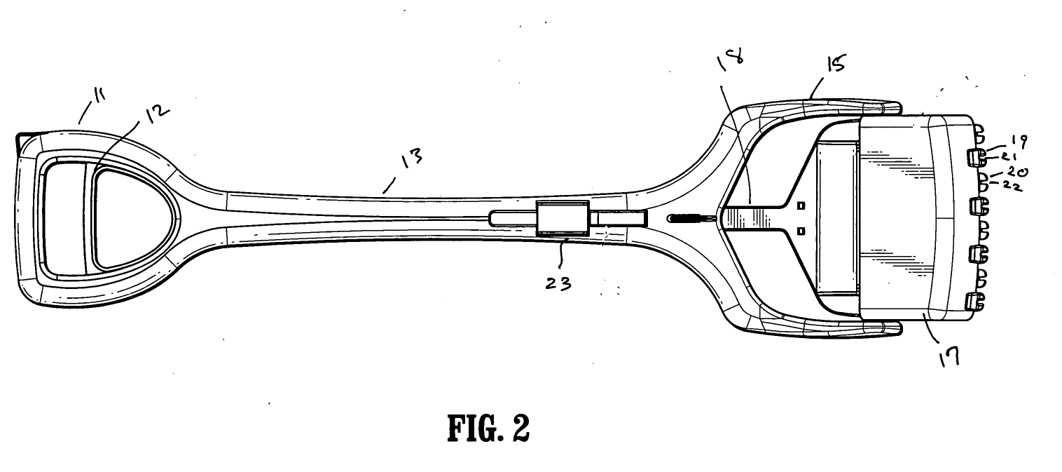

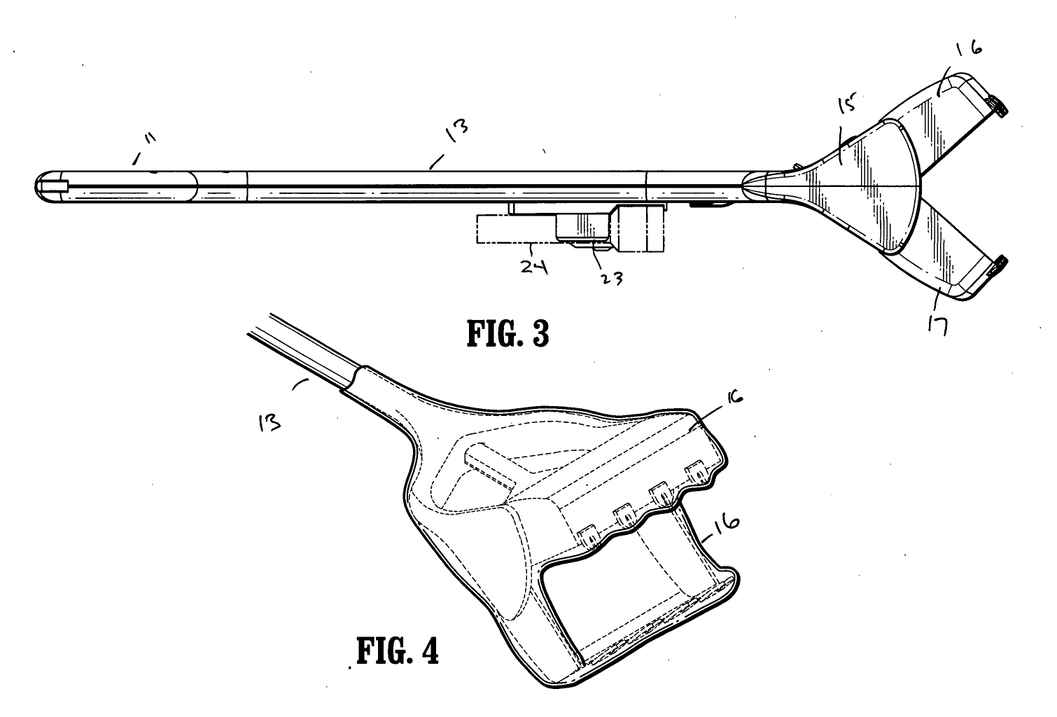

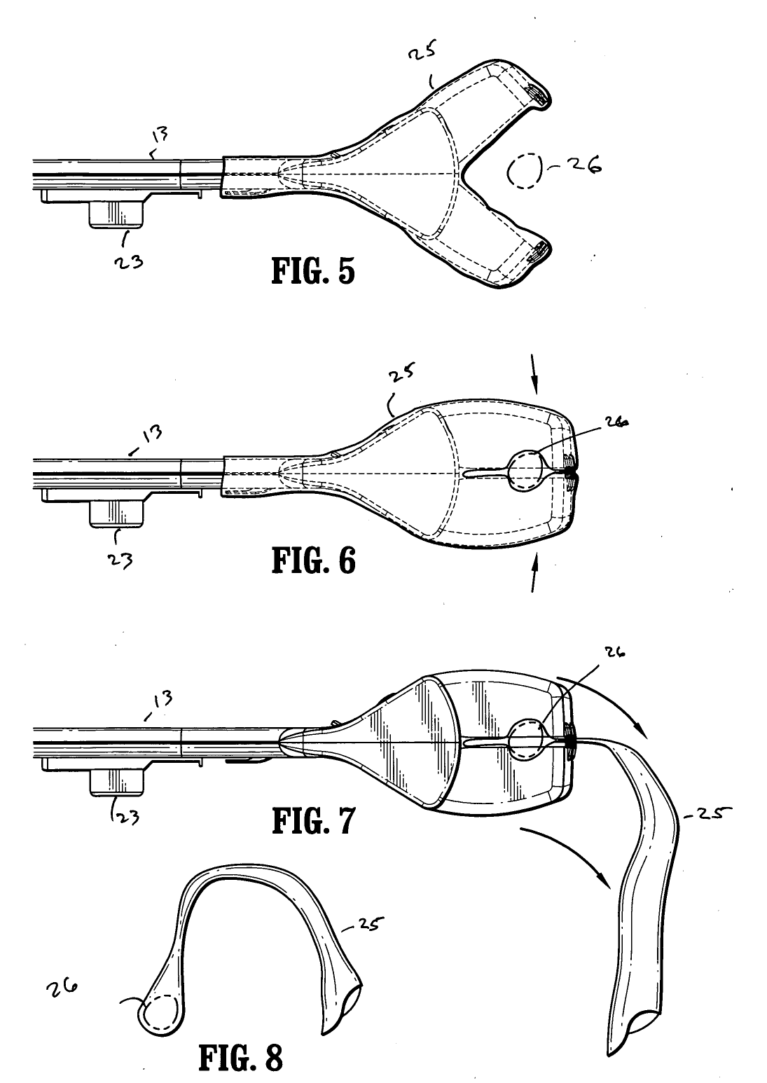

A container (10) according to the first embodiment of the present invention comprises a body (12) and a lid (14). The body (12) has a floor (16), a sidewall (18), and an open top. The body (12) as shown has a round profile, but it could be any other shape including but not limited to a square or a rectangle. The lid (14) is shaped to cover the open top when in the closed position as shown in FIG. 4, and is attached to the body (12) by a hinge (20). A lock (22) comprises a first lock tab (24) adapted to be received into a lock retainer (26) to hold the lid (14) in the closed position as shown in FIG. 2. A first set of perforations (28) on the lid (14) are in communication with an interior chamber formed by the body (12). A second set of perforations (30) in the floor (16) of the body (12) are in communication with an interior chamber formed by the body (12).

Operation of the first embodiment container is illustrated in FIGS. 6A-6D and in FIG. 7. Referring to FIG. 6A, while the lid (14) is opened, beverage matter (32) such as coffee grounds is loaded into the body (12) interior. The lid (14) is closed and locked as shown in FIG. 6B. A filter holding component (34) of a conventional coffee machine (not shown) having a receiving space (36) is opened or manipulated so that a user can access it. The container (10) loaded with coffee grounds is grasped by a user's hand (38) as shown in FIG. 6D, and placed into the receiving space (36) as shown in FIG. 7. The holding component (34) is re-positioned or manipulated into a position or condition as provided for during normal use of the conventional coffee machine. The coffee machine is then operated according to its normal instructions. Water, heated water, and/or steam is emitted by the coffee machine in a direction and manner in which it passes through the perforations (28, 30) so that brewed beverage, such as coffee, is emitted from the container (10) into a conventional holding container (not shown) or drinking vessel (not shown).

A second embodiment of the present invention comprises a container (100) having a body (112) and a lid (114). The body (112) has a floor (16), a sidewall (118), and an open top. The body (112) as shown has a round profile, but it could be any other shape including but not limited to a square or a rectangle. The lid (114) is shaped to cover the open top when in the closed position as shown in FIG. 4, and is attached to the body (12) by a twist-on and twist-off motion due to opposed bayonet grooves (120) that cooperates with bayonet lock tabs (122). When locked, the lid (114) is held in the closed position as shown in FIG. 9. A first set of perforations (128) on the lid (114) are in communication with an interior chamber formed by the body (112). A second set of perforations (130) in the floor (16) of the body (12) are in communication with an interior chamber formed by the body (12).

Operation of the second embodiment container is illustrated in FIGS. 13A-13D and in FIG. 14. Referring to FIG. 13A, while the lid (114) is opened, beverage matter (132) such as coffee grounds is loaded into the body (112) interior. The lid (114) is closed and locked as shown in FIG. 13B. A filter holding component (134) of a conventional coffee machine (not shown) having a receiving space (136) is opened or manipulated so that a user can access it. The container (110) loaded with coffee grounds is grasped by a user's hand (138) as shown in FIG. 13D, and placed into the receiving space (136) as shown in FIG. 14. The holding component (134) is re-positioned or manipulated into a position or condition as provided for during normal use of the conventional coffee machine. The coffee machine is then operated according to its normal instructions. Water, heated water, and/or steam is emitted by the coffee machine in a direction and manner in which it passes through the perforations (128, 130) so that brewed beverage, such as coffee, is emitted from the container (110) into a conventional holding container (not shown) or drinking vessel (not shown).

The presently disclosed and claimed invention can be used with a variety of beverage machines having a variety of features including, but not limited to, automatic controls and timers, automated features, dual stations such as a carafe-filling station and a single-serve station for filling a single vessel or cup, thermal or non-thermal containers, and various other features.

While the preferred embodiments of the present invention have been herein described, various modification may be made without departing from the scope of the present invention.

What is claimed is:

1) A container and filter assembly for holding beverage matter through which liquid or steam is passed to produce a brewed beverage, said assembly comprising
a body having a bottom wall, a side wall and an open top generally forming a cup;
at least one bottom wall perforation on said bottom wall;
a lid selectively moveable between a position in which said lid is positioned on said body and covers said open top, and a position in which said lid does not cover said open top; and
at least one lid perforation on said lid.

2) A container according to claim 1, further comprising
a hinge connecting said lid and said body.

3) A container according to claim 1, further comprising
a lock for locking said lid and said body in a closed position.

4) A container according to claim 1, further comprising
a bayonet-lock system for locking said lid to said body, and unlocking said lid from said body, in a twisting motion.

5) A method of inserting dry beverage matter into a beverage brewing machine, said method comprising
providing a body having a bottom wall, a side wall and an open top generally forming a cup;
providing at least one bottom wall perforation on said bottom wall;
providing a lid selectively moveable between a position in which said lid is positioned on said body and covers said open top, and a position in which said lid does not cover said open top;
providing at least one lid perforation on said lid;
opening said lid relative to said body;
putting said dry beverage matter into said body;
closing said lid relative to said body so that said lid covers said open top;
placing said body containing beverage matter into a brewing machine beverage matter receiving compartment; and
causing said brewing machine to operate to produce a beverage.
